(19) United States
(12) Patent Application Publication
(10) Pub. No.: US 2024/0208062 A1
(43) Pub. Date: Jun. 27, 2024

(54) CONTEXTUALLY AWARE ROBOTIC DEVICE MANAGEMENT

(71) Applicant: International Business Machines Corporation, Armonk, NY (US)

(72) Inventors: Akash U. Dhoot, Pune (IN); Sarbajit K. Rakshit, Kolkata (IN); Saraswathi Sailaja Perumalla, Visakhapatnam (IN); Venkata Ratnam Alubelli, Visakhapatnam (IN)

(21) Appl. No.: 18/145,964

(22) Filed: Dec. 23, 2022

(51) Int. Cl. B25J 9/16

(52) U.S. Cl. CPC B25J 9/1671; B25J 15/0066

(57) ABSTRACT

A processor may receive environment data associated with a robotic device in an environment. The processor may analyze the environment data to identify one or more activities the robotic device may perform in the environment. The processor may generate one or more simulations associated with the one or more activities and the robotic device. The processor may determine one or more limitations of the robotic device associated with the one or more activities. The processor may identify, responsive to determining one or more limitations, one or more apparatuses. The one or more apparatuses may be associated with the one or more limitations.

### BACKGROUND

The present disclosure relates generally to the field of artificial intelligence, and more particularly to the field of robotic devices.

As technology associated with robotics has advanced, a greater understanding of how robotics can be applied to different industrial operations has also developed. The area of robotics has been used to revolutionize industrial manufacturing and assembly of various products. While the term robotics covers a cornucopia of devices and technology, often a common example of robotic devices used in manufacturing and industrial operations is the robotic arm. In such operations, robotic arms may be configured with various attachments to perform diverse tasks.

### SUMMARY

Embodiments of the present disclosure include a method, computer program product, and system for managing an one or more personal devices in a smart environment.

A processor may receive environment data associated with a robotic device in an environment. The processor may analyze the environment data to identify one or more activities the robotic device may perform in the environment. The processor may generate one or more simulations associated with the one or more activities and the robotic device. The processor may determine one or more limitations of the robotic device associated with the one or more activities. The processor may identify, responsive to determining one or more limitations, one or more apparatuses. The one or more apparatuses may be associated with the one or more limitations.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an embodiment of a robotic device management system, in accordance with the present disclosure.

FIG. 2 illustrates a flowchart of a method for managing a robotic device system, in accordance with embodiments of the present disclosure.

FIG. 3 depicts a block diagram illustrating an embodiment of a computer system and the components thereof, upon which embodiments described herein may be implemented in accordance with the present disclosure.

FIG. 4 depicts a block diagram illustrating an extension of the computing system environment of FIG. 1, wherein the computer systems are configured to operate in a network environment (including a cloud environment), and perform methods described herein in accordance with the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of artificial intelligence (AI), and more particularly to robotic devices. While the present disclosure is not necessarily limited to such applications, various aspects of the disclosure may be appreciated through a discussion of several examples using this context.

Robotics have revolutionized how various objects are manufactured and assembled. Robotics are not only used to assemble small objects, but can also be used to assemble and manufacture large machines and structures. While the term robotics covers numerous types of devices and technology, a common example of robotic devices used in manufacturing and assembling operations is the robotic arm. While various embodiments contemplated herein refer to the use of a robotic arm, robotic fingers, robotic grippers or any other mechanisms, such embodiments are used as examples only and should not be construed as limiting. Robotic devices have been shown to be successfully used for the assembly of large structures and performing various manufacturing processes (e.g., assembly or deconstruction).

Robotic devices may be customized to perform a particular activity. In some instances, the robotic device (e.g., robotic arm) may be completely engaged or busy (e.g., the robotic apparatuses are in use) while performing an activity or task (e.g., material and/or robotic device movement, mechanical activities, physical activities, etc.). In some instances, an activity may be performed more optimally with additional robotic devices (e.g., additional robotic device). Unfortunately, in some instances, the space available within an environment, where the activity or task is being performed, may limit the amount and/or size of robotic devices that may perform or contribute to completing the activity.

As a result of the space limits imposed on the number of robotic devices that may be configured within an environment to perform a particular activity, often result in a significant increase in time required to perform the activity as well as a decrease in overall productivity. As such, there is a desire for a solution that provides the benefits of multiple robotic devices, while also minimizing the number of robotic devices that may be used to perform the activity in the environment, particularly an environment that has limited space and/or irregular areas that may limit robotic access.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will be readily understood that the instant components, as generally described and illustrated in the figures herein, may be arranged and designed in a wide variety of different configurations. Accordingly, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the FIGS., any connection between elements can permit one-way and/or two-way communication even if the depicted connection is a one-way or two-way arrow.

Also, any device depicted in the drawings can be a different device. For example, if a mobile device is shown sending information, a wired device could also be used to send the information. The term “module” may refer to a hardware module, software module, or a module may be a combination of hardware and software resources. Embodiments of hardware-based modules may include self-contained components such as chipsets, specialized circuitry, one or more memory devices and/or persistent storage. A software-based module may be part of a program, program code or linked to program code containing specifically programmed instructions loaded into a memory device or persistent storage device of one or more data processing systems operating as part of the computing environment (e.g., environment 102).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

In embodiments discussed herein, solutions are provided in the form of a method, system, and computer program product, for managing robotic devices in a contextually aware environment. Embodiments contemplated herein may ensure that robotic devices are able to perform their various functions in an optimal manner.

Before turning to the FIGs. it is noted that the benefits/novelties and intricacies of the proposed solution are that:

The robotic device management system may be configured to perform digital twin simulation of the area of activity (e.g., environment). The robotic device management system may be used to identify limitations of a robotic device based on the activity the robotic device is performing and identify if the robotic device may benefit from additional support (e.g., attaching additional apparatuses). In such embodiments, the robotic device management system may dynamically couple one or more additional arms (e.g., primary and/or secondary apparatuses) to one or more robotic devices. By dynamically coupling the one or more additional arms the robotic device may perform a particular activity more effectively.

The robotic device management system may use digital twin simulation techniques (e.g., enabled using AI and machine learning technology) to identify what types of robotic arms or other robotic attachments (e.g., robotic grippers) may be available. In some embodiments, robotic device management system may configure the one or more digital twin simulations to determine and identify the various abilities of each robotic arm or apparatus and how each robotic arm or apparatus may be appropriately positioned to perform the activity (e.g., how and/or where the apparatus is attached to the robotic device).

In some embodiments, robotic device management system may configure a robotic device to have an attachable primary arm and/or a secondary arm. The attachable primary arm and/or a secondary arm may be used to perform various activities. In such embodiments, the primary and secondary arm may be configured to perform the particular activity in a collaborative manner with other attachments on the same robotic device and/or in collaboration with additional robotic devices. The apparatus may support the other arm/apparatus while the activity is performed.

The robotic device management system may detach/attach the arm (e.g., one or more apparatuses) from a first robotic device to a second robotic device. This detachment/attachment may allow the first robotic device to perform the physical mechanical activity along with or in collaboration with the second robotic device. In such embodiments, the robotic devices may be collaborating with each other to perform the exchange of arms (e.g., by detaching/attaching the robotic arm).

The robotic device management system may be configured to analyze environment data and identify, based on the contextual activity, that a secondary apparatus of a first robotic device may be transferred from the first robotic device to a second robotic device. In such embodiments the second robotic device can perform the physical and mechanical activity with the first robotic device.

The robotic device management system may be configured to collect and analyze environment data associated with a criticality level of the activity (e.g., how important is the activity and/or how quickly the activity should be completed) as well as the total amount of space available in the environment (e.g., the smaller the space the fewer robotic devices may be able to perform a particular activity). The robotic device management system may use the environment data collected and identify how many additional secondary arms, additional fingers, and/or grippers may be attached to any particular robotic device in the system.

The robotic device management system may be configured to dynamically attach and/or detach one or more apparatuses (e.g., robotic arms, fingers, grippers, etc.). These additional apparatuses may be configured to enable the various robotic devices to perform different or additional functions, such as fly, crawl, or otherwise be mobile in such a way that enhances the robotic devices ability to perform one or more activities in the environment.

The robotic device management system may be configured to generate one or more simulations using digital twin technology. In such embodiments, the robotic device management system may be configured to identify what type of apparatuses may enhance a particular robotic device's ability to optimally perform an activity based on the contextual situation occurring in the environment. In some embodiments a secondary robotic device may be configured to work in concert with a primary robotic device to complete an activity more optimally. In other embodiments, the robotic device management system may identify an apparatus (e.g., secondary robotic arm) that may be attached to a robotic device may allow the robotic device to complete the activity more optimally.

The robotic device management system may be configured to utilize digital twin simulation and/or gamification principles. In these embodiments, the robotic device management system may use digital twin simulation and/or gamification principles to identify the workflow and sequence of activates that secondary robotic apparatus may be able to perform in a contextual situation associated with the environment. In such embodiments, the robotic device management system may be configured to program a robotic device to perform the activity based on the identified workflow and activity sequence.

The robotic device management system may be configured to analyze environment data to identify if an anomaly has occurred and/or predict whether an anomaly may occur (e.g., using AI and machine learning based analysis) in the environment. In such embodiments, the robotic device management system may be configured to analyze the associated anomaly environment data to reevaluate the identified workflow and activity sequence of the one or more robotic devices in the environment. Once an updated workflow and activity sequence is identified, the robotic device management system may be configured to instruct the one or more robotic devices to perform the various activities based on the updated workflow.

The robotic device management system may be configured to generate a historical corpus not only associated with the various apparatuses and robotic devices that may be used to perform the one or more activities in the environment, but also with the activities performed, potential anomalies, various contextual situations, etc. In some embodiments, the robotic device management system may be configured to leverage the historical corpus while performing simulations and/or generating digital twins of the robotic device and/or the environment. In such embodiments, the robotic device management system may be configured to derive and identify how many and the type of apparatuses (e.g., arms, fingers, grippers, etc.) that may be used in such a way that enables the one or more robotic devices to optimally perform a particular activity.

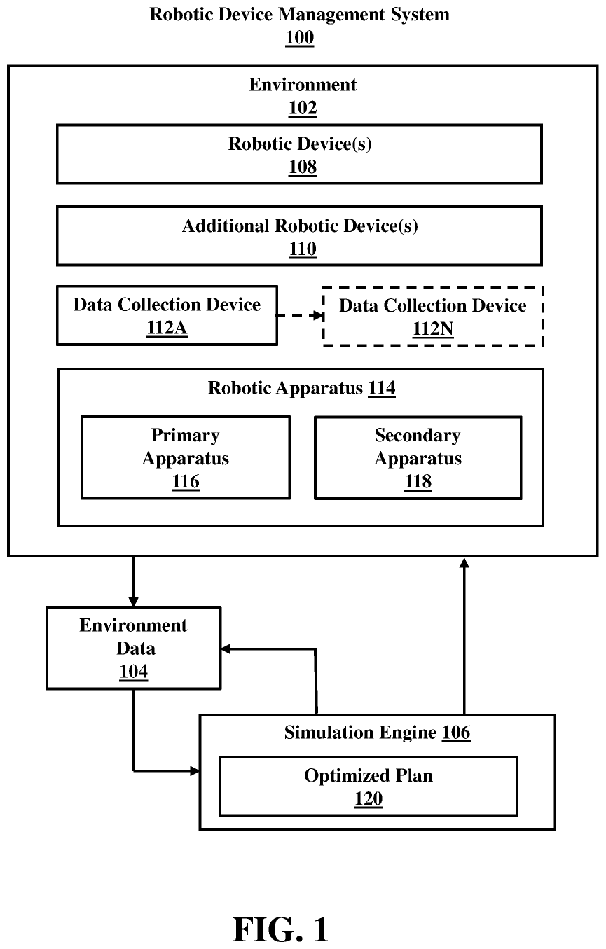

Turning now to the figures, FIG. 1 depicts robotic device management system 100, in accordance with embodiments of the present disclosure. In embodiments, device management system 100 leverages the use of AI and machine learning to prevent external devices from accessing protected in an environment while the external device is performing an activity. FIG. 1 provides an illustration of only one embodiment and does not imply any limitations with regard to the environments in which different embodiments may be implemented. Many modifications to the depicted environment may be made by those skilled in the art without departing from the scope of the invention as recited by the claims.

In embodiments, robotic device management system 100 may include, but is not limited to, environment 102, environment data 104, and simulation engine 106. In embodiments, environment may include any space or area that may utilize robotic devices. These spaces/areas may include, but are not limited to, a room, conference hall, home, factory, businesses, manufacturing unit, construction site, underground sea cave, or any combination thereof. In embodiments, environment 102 may include robotic device(s) 108, additional robotic device(s) 110, data collection devices 112A-112N, and one or more robotic apparatuses 114. While embodiments contemplated herein may often refer to one robotic device 108 configured within environment 102, environment 102 may include any number of robotic devices 108 (e.g., additional robotic devices 110).

In embodiments, robotic device management system 100 may configure robotic device 108 to perform one or more activities in environment 102. The one or more activities may be associated with physical tasks (e.g., moving material from one location to another location) and/or mechanical tasks (e.g., performing subtractive manufacturing processes) that may be performed by a robotic devices (e.g., robotic devices 108 and/or additional robotic devices 110). For example, robotic device 108 may be configured to enter a building construction site with an unstable building structure. In this example, robotic device 108 may be configured to perform activities associated with shoring up the unstable building structure to ensure the building construction site is safe for workers to safely occupy. The activities from this example may include, but are not limited to, moving building support material from one location to the area/location where they are to be used (e.g., physical activity) and assembling the building support material to repair the unstable building structure using a drilling mechanism (e.g., mechanical activity).

In embodiments, robotic device 108 may refer to at least a robotic base, capable of having one or more apparatuses 114 attached. In some embodiments, robotic device 108 may be configured with one or more attachment areas where one or more apparatuses (e.g., robotic apparatuses 114) may be attached and/or dethatched from robotic device 108. In embodiments, the one or more attachment areas of robotic device 108 may be configured to use hydraulic, pneumatic, magnetic (e.g., electromagnetic coupling), and/or mechanical (e.g., fastening via clipping, twisting, bolting etc.) means to attach/couple the one or more apparatus 114.

In embodiments, one or more apparatuses 114 (e.g., robotic apparatuses) may refer to any attachment that may be configured as part of robotic device 108. One or more apparatuses may include, but are not limited to, robotic arms, robotic hands, robotic fingers, robotic grippers, and/or, additional robotic devices, (e.g., apparatuses that may enable robotic device 108 to move, crawl, fly, climb, etc.) from one area (e.g., within environment 102) to another area. While in some embodiments, one or more apparatuses 114 may only be attached to robotic device 108, in other embodiments, some or all of the one or more apparatuses may be attached/coupled to other apparatuses (e.g., robotic fingers may be attached to a robotic hand). In some embodiments, robotic device management system 100 may distinctly categorize the one or more apparatuses 114 as primary apparatuses 116, and secondary apparatuses 118. While in some embodiments, the one or more apparatuses 114 are configured with the same or similar capabilities, in other embodiments, some or all of the one or more apparatuses 114 may be different.

In embodiments, robotic device management system 100 may be configured to receive/collect environment data 104 associated with one or more robotic devices (e.g., robotic device 108 and/or additional robotic devices 110) and environment 102. Environment data 104 may include, but is not limited to, information/data associated with: i) the configuration of environment 102 (e.g., the size of the space available or potential obstacles within environment 102); ii) the types of robotic devices (e.g., robotic devices 108 and additional robotic devices 110) and each robotic device's characteristics (e.g., device performance capabilities, size, coupling/attaching means, etc.); iii) number of robotic devices (e.g., robotic devices 108 and additional robotic devices 110) and/or apparatuses 114; iv) type of apparatuses 114 (e.g., primary apparatuses 116 and/or secondary apparatuses 118) and capabilities of each apparatuses' characteristics (e.g., performance capabilities, size, coupling/attaching means, etc.); v) information associated with the robotic devices interacting with environment 102 (e.g., the location of robotic device 108 and its proximity to additional robotic devices 110); vi) information associated with one or more activities associated with environment 102 (e.g., types and criticality of the activities); vii) real-time information associated with the one or more activities as the associated with environment 102 (e.g., stage of activity, length of time to complete activity, efficiency of activity, etc.); viii) information/data generated from various analyses contemplated herein (e.g., information/data generated by AI and machine learning analysis via simulation engine 106); xi) predicted risk or support that may be required for one or more robotic devices and xii), databases having information/data associated with the performance of the same or similar activates (e.g., historical information), such as data relating to how much time was needed to complete the same/similar activity or stage of activity, how previous robotic devices (e.g., robotic device 108 and/or additional robotic devices 110) performed various activities and what apparatuses may have been used, and how one or more factors (e.g., increasing the number of robotic devices and/or available apparatuses) may impact the performance of the activity by the one or more robotic devices (e.g., factors that may increase or decrease the time needed to complete a particular activity).

In embodiments, robotic device management system 100 may be configured to store environment data collected over time in a historical repository. The historical repository may include any environment data contemplated herein. In embodiments, robotic device management system 100 may access the historical repository to generate one or more simulations using AI and machine learning capabilities (e.g., simulation engine 106). The information generated from these analyses may be considered robotic device management system 100 data and may also be stored within the historical repository.

In embodiments, robotic device management system 100 may receive/collect environment data 104 from one or more data collection devices 112A-112N. Data collection devices 112A-112N may include, but are not limited to devices such as, Internet of Things (IoT) devices, cameras, infrared sensors, ultrasounds, chemical sensors, wearable devices (e.g., device attached to robotic device 108 or a user into environment 102), smart devices, or any combination thereof.

In embodiments, robotic device management system 100 may configure one or more data collection devices 112A-112N to receive/collect environment data 104 associated with environment 102 in real-time and/or to collect environment data 104 over a particular time duration. Such environment data 104 may be stored in a historical repository and accessed as needed by robotic device management system 100 by simulation engine 106 (e.g., when using AI and machine learning capabilities performing the various simulations/analyses contemplated herein). While some data collection devices 112A-112N may be configured within the environment 102, in some embodiments, other data collection devices 112A-112N may be further configured within or associated with robotic devices 108, additional robotic devices robots 109, and/or apparatuses 114.

In embodiments, robotic device management system 100 may be configured to analyze environment data 104 using AI and machine learning techniques (e.g., via simulation engine 106). In these embodiments, robotic device management system 100 may be configured to analyze environment data 104 to identify one or more activities associated with environment 102. In some embodiments, environment data 104 may be analyzed using visual analysis of environment 102. For example, in some embodiments, robotic device management system 100 may use one or more data collection devices 112A-112N to receive an IoT feed associated with environment 102 (e.g., environment data 104). The visual analysis may identify what activities and/or potential obstacles that a robotic device may encounter in environment 102.

In some embodiments, robotic device management system 100 may configure simulation engine 106 to generate one or more simulations of environment 102 and/or one or more robotic devices (e.g., robotic devices 108 and/or additional robotic devices 110) using environment data 104. These simulations may be based on environment data 104 received/collected in real-time and/or retrieved from the historical repository. In some embodiments, the one or more simulations generated may refer to one or more digital twins of the one or more robotic devices and environment 102 where one or more activities may be performed. Robotic device management system 100 may analyze the one or more digital twins to determine, and in some embodiments predict, effects including, but not limited to: i) various aspects of the various capabilities and characteristics of the one or more robotic devices that may be used in environment 102 to perform a particular activity (e.g., robotic device strength); ii) amount of available space in environment 102; iii) direction of where in environment 102 the one or more activities are to be performed; iv) what obstacles associated with environment 102 may impact the robotic device while it is performing the task or activity; v) current apparatuses attached to robotic device 108 and their capabilities (e.g., the movement pattern associated with a robotic arm, the potential movement of a robotic device when multiple robotic arms are attached).

In embodiments, robotic device management system 100 may be configured to use the one or more simulations and/or digital twins (e.g., simulation engine 106) to determine one or more limitations of robotic device 108. In embodiments, these one or more limitations may be associated with robotic device 108 performing one or more activities in environment 102 and may refer to instances when robotic device 108 may require support (e.g., the robotic device 108 is unable to perform the activity efficiently). The identified one or more limitations may include, but are not limited to, a decrease in efficiency (e.g., robotic device 108 is slow to complete an activity), a lack of support while performing an activity, inhibited or unable to complete an activity, or any combination thereof.

In embodiments, responsive to determining one or more limitations, robotic device management system 100 may be configured to identify one or more apparatuses (e.g., robotic apparatuses 114) associated with the one or more limitations. In these embodiments, robotic device management system 100 may analyze environment data 104 to determine which limitations associated with robotic device 108 may be reduced or eliminated with the use of one or more apparatuses. In embodiments, robotic device management system 100 may generate one or more simulations associated with the one or more limitations and determine which of the one or more apparatuses may address the one or more limitations. While in some embodiments robotic device management system 100 may be configured to attach one or more apparatuses 114 to robotic device 108, in other embodiments, robotic device management system 100 may be configured to issue an additional robotic device 110 with one or more apparatuses to support robotic device 108 and address the one or more limitations. In embodiments, robotic device 108 and additional robotic device 110 may be the same/similar robotic device with the same/similar capabilities, while in other embodiments, robotic device 108 and additional robotic device 110 may be different devices. These different devices may have varied capabilities.

While the robotic attachments contemplated herein may be generally referred to as one or more apparatuses 114, in some embodiments, robotic device management system 100 may further classify the one or mor apparatuses 114 as primary apparatuses 116 and secondary apparatuses 118. In embodiments, while a primary apparatus 116 may be attached to robotic device 108 (e.g., attached as a permanent component of robotic device 108 or removably attached to robotic device via one or more attachment areas), a secondary apparatus 118 may be attached to a primary apparatus (e.g., an apparatus, such as a robotic arm, that is already attached to robotic device 108).

While embodiments contemplated herein may often refer to primary apparatus 116 as one or more robotic arms, any similarly configured apparatuses may be utilized and attached to robotic device 108 and/or additional robotic devices. Secondary apparatuses 118 may include, but are not limited to, robotic hand, robotic mobile components, grippers, robotic support arm, robotic tools, robotic fingers, or any other attachable robotic device.

In embodiments where an apparatus is further attached to a different secondary apparatus on robotic device 108, those apparatuses may still be referred to and understood to be secondary apparatuses. For example, a robotic arm (e.g., primary apparatus) may be coupled to robotic device 108. In this example, a robotic hand (e.g., secondary apparatus) with additional attachment areas may be attached to the robotic arm (e.g., primary apparatus). In embodiments where robotic device management system 100 determines further support is needed (e.g., identifies one or more limitations via digital twin), robotic device management system 100 may attach robotic fingers/grippers (e.g., secondary apparatus) to the available attachment areas of the robotic hand (e.g., secondary apparatus) that is already attached to the robotic arm (e.g., primary apparatus).

In embodiments, robotic device management system 100 may be configured to identify a primary apparatus 116 from the one or more apparatuses 114 based on the one or more limitations (e.g., robotic device 108 may be unable to support a structural beam while performing an assembly process). Once the primary apparatus is identified, robotic device management system 100 may determine an optimal method of attaching the primary apparatus to the robotic device. In these embodiments, robotic device management system 100 may generate digital twins associated with the robotic devices in environment 102 using environment data 104 to identify various methods that may be used to attach the one or more primary apparatuses 116. Robotic device management system 100 may then identify the most optimal way of attaching the apparatus to robotic device 108 from the digital twin simulations (e.g., via simulation engine 106). Once the optimal method has been identified, robotic device management system 100 may attached the primary apparatus to the robotic device using the optimal method. In some embodiments, the optimal method may include dethatching and attaching one or more apparatuses 114 (e.g., primary apparatuses 116 and/or secondary apparatuses 118) to robotic device 108.

In some embodiments, robotic device management system 100 may analyze (e.g., via one or more simulations and/or digital twins) environment data 104 and the one or more robotic devices 108 with the primary apparatus 116 attached. While in some embodiments robotic device management system 100 may determine that robotic device 108 has the optimal number of apparatuses 114 attached to efficiently perform the activity, in other embodiments, robotic device management system 100 may determine there is still a lack of support. In these embodiments, robotic device management system 100 may identify one or more secondary limitations associated with robotic devices 108 with the primary apparatus and the one or more activities. In these embodiments, robotic device management system 100 may identify a secondary apparatus 118 from the one or more apparatus 114 that may reduce or eliminate the one or more secondary limitations.

In embodiments, robotic device management system 100 may be configured to simulate the secondary apparatus 118 and the robotic device 108 with the primary apparatus 116 attached using digital twin simulations using simulation engine 106. In these embodiments, robotic device management system 100 may be configured to determine to the optimal method of attaching the secondary apparatus 118 to robotic device 108. Once the one or more secondary apparatuses 118 has been determined, robotic device management system 100 may attach the secondary apparatus 118 to robotic device 108 with the optimal method of attaching the secondary apparatus 118.

In embodiments, robotic device management system 100 may attach the primary apparatus 116 and secondary apparatus 118 at the same time. In these embodiments, robotic device management system 100 may be configured to identify a primary apparatus 116 and a secondary apparatus 118 from the one or more apparatuses 114 based, at least in part, on the one or more limitations. In these embodiments, robotic device management system 100 may determine the optimal method of attaching the primary apparatus 116 and the secondary apparatus 118 to robotic device 108. Robotic device management system 100 may then attach the primary apparatus and the secondary apparatus to the robotic device 108 with the optimal method. In some embodiments, while the activity is being performed by the primary apparatus 116, robotic device management system 100 may configure the secondary apparatus 118 to support the primary apparatus 116.

In embodiments, robotic device management system 100 may use simulation engine 106 to analyze environment data 104 associated with environment 102 to identify an additional robotic device 110 performing the one or more activities. Robotic device management system 100 may simulate additional robotic device 110 to determine the one or more limitations of the additional robotic device 110 to identify, responsive to determining the one or more limitations of the additional robotic device, one or more other apparatuses 114. In these embodiments, the one or more other apparatuses 114 may be associated with the one or more limitations of additional robotic device 110. In some embodiments, robotic device management system 100 may configure robotic device 108 and additional robotic device 110 to perform the activity in a collaborative manner that enables each robotic device to provide support to efficiently perform the activity. In some embodiments, based on the identified one or more limitations associated with the activities, robotic device management system 100 may configure the one or more apparatuses 114 (e.g., either primary apparatus 116 or secondary apparatus 118) to independently move from one robotic device to another (e.g., move from robotic device 108 to additional robotic device 110).

In embodiments, once the optimal number of apparatuses 114 are attached to robotic device (e.g., robotic devices 108 and/or additional robotic devices 110), robotic device management system 100 may perform the activity in environment 102. In these embodiments, robotic device management system 100 may control the primary apparatuses 116 and secondary apparatuses 118 as the activity is performed.

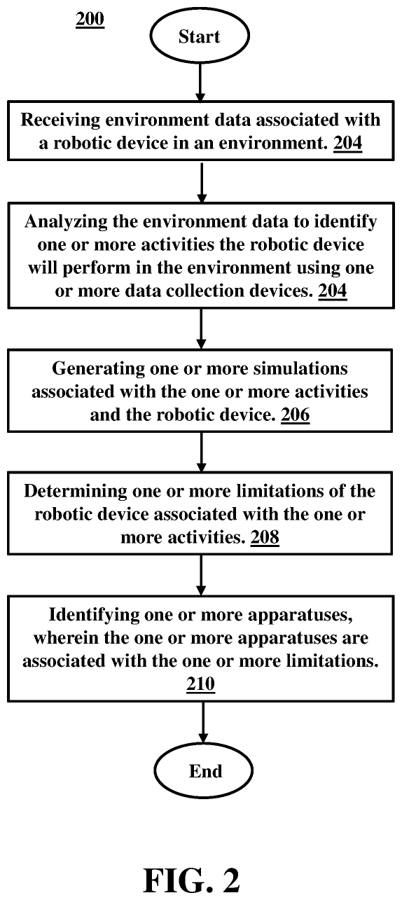

Referring now to FIG. 2, a flowchart illustrating an example method 200 for managing robotic devices in a contextually aware environment (e.g., environment 102), in accordance with embodiments of the present disclosure. FIG. 2 provides an illustration of only one implementation and does not imply any limitations with regard to the environments in which different embodiments may be implemented. Many modifications to the depicted environment may be made by those skilled in the art without departing from the scope of the invention as recited by the claims.

In some embodiments, the method 200 begins at operation 202. At operation 202 a processor may receive environment data associated with a robotic device in an environment. The method 200 proceeds to operation 204.

At operation 204, a processor may analyze the environment data to identify one or more activities the robotic device performs in the environment using one or more data collection devices. The method 200 proceeds to operation 206.

At operation 206, a processor may generate one or more simulations associated with the one or more activities and the robotic device. In some embodiments, the processor may base the generation of the one or more simulations (e.g., simulations associated with the one or more activities and the one or more robotic devices) on one or more digital twins of the robotic device and the environment. The method 200 proceeds to operation 208.

At operation 208, a processor may determine one or more limitations of the robotic device associated with the one or more activities. The method 200 proceeds to operation 210.

At operation 210, a processor may identify one or more apparatuses. In some embodiments, the one or more apparatuses are associated with the one or more limitations. In some embodiments, as depicted in FIG. 2, after operation 210, the method 200 may end.

In some embodiments, discussed below there are one or more operations of the method 200 not depicted for the sake of brevity and which are discussed throughout this disclosure. Accordingly, in some embodiments, the processor may identify a primary apparatus from the one or more apparatuses. In these embodiments, the primary apparatus may be based, at least in part, on the one or more limitations. The processor may determine an optimal attachment method of attaching the primary apparatus to the robotic device. The processor may then attach the primary apparatus to the robotic device with the optimal method.

In some embodiments, the processor may analyze environment data and one or more robotic devices with the primary apparatus. The processor may determine one or more secondary limitations associated with the one or more robotic devices with the primary apparatus and one or more activities. In embodiments, the processor may identify a secondary apparatus from the one or more apparatuses. In some embodiments, the secondary apparatus may be based, at least in part, on one or more secondary limitations.

In some embodiments, the processor may simulate the secondary apparatus and the one or more robotic device with the primary apparatus. The processor may then determine an optimal method of attaching the secondary apparatus to the robotic device. The processor may attach the secondary apparatus to the robotic device with the optimal method of attaching the secondary apparatus.

In some embodiments, the processor may identify a primary apparatus and a secondary apparatus from the one or more apparatuses. In these embodiments, the primary apparatus and the secondary apparatus may be based, at least in part, on one or more limitations. The processor may determine an optimal method of attaching the primary apparatus and the secondary apparatus to the robotic device. The processor may then attach the primary apparatus and the secondary apparatus to the robotic device with the optimal method.

In some embodiments, the processor may analyze the environment data associated with the environment to identify an additional robotic device performing the one or more activities. The processor may then simulate the additional robotic device to determine one or more limitations of the additional robotic device. Responsive to determining one or more limitations of the additional robotic device, the processor may identify one or more other apparatuses. In some embodiments, the one or more other apparatuses may be associated with the one or more limitations of the additional robotic device.

It is noted that various aspects of the present disclosure are described by narrative text, flowcharts, block diagrams of computer systems and/or block diagrams of the machine logic included in computer program product (CPP) embodiments. With respect to any flowcharts (depending upon the technology involved) the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices. The storage media may collectively include machine readable code corresponding to instructions and/or data for performing computer operations.

A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination thereof. A computer-readable storage medium should not be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation or garbage collection, but this does not render the storage device as transitory because the data is not transitory while it is stored.

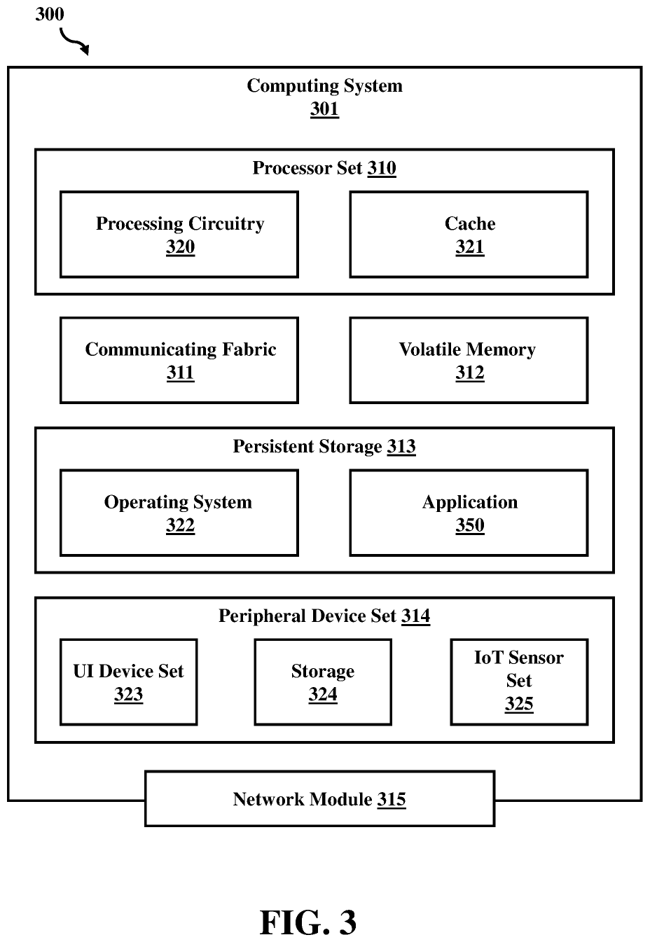

Referring now to FIG. 3, illustrated is a block diagram describing an embodiment of a computing system 301 within in a computing environment, which may be a simplified example of a computing device (i.e., a physical bare metal system and/or a virtual system) capable of performing the computing operations described herein. Computing system 301 may be representative of the one or more computing systems or devices implemented in accordance with the embodiments of the present disclosure and further described below in detail. It should be appreciated that FIG. 3 provides only an illustration of one implementation of a computing system 301 and does not imply any limitations regarding the environments in which different embodiments may be implemented. In general, the components illustrated in FIG. 3 may be representative of an electronic device, either physical or virtualized, capable of executing machine-readable program instructions.

Embodiments of computing system 301 may take the form of a desktop computer, laptop computer, tablet computer, smart phone, smart watch or other wearable computer, mainframe computer, server, quantum computer, a non-conventional computer system such as an autonomous vehicle or home appliance, or any other form of computer or mobile device now known or to be developed in the future that is capable of running a program 350, accessing a network 302 or querying a database, such as remote database 330. Performance of a computer-implemented method executed by a computing system 301 may be distributed among multiple computers and/or between multiple locations. Computing system 301 may be located as part of a cloud network, even though it is not shown within a cloud in FIGS. 3-2. Moreover, computing system 301 is not required to be in a cloud network except to any extent as may be affirmatively indicated.

Processor set 310 includes one, or more, computer processors of any type now known or to be developed in the future. Processing circuitry 320 may be distributed over multiple packages. For example, multiple, coordinated integrated circuit chips. Processing circuitry 320 may implement multiple processor threads and/or multiple processor cores. Cache 321 may refer to memory that is located on the processor chip package(s) and/or may be used for data or code that can be made available for rapid access by the threads or cores running on processor set 310. Cache 321 memories can be organized into multiple levels depending upon relative proximity to the processing circuitry 320. Alternatively, some, or all of cache 321 of processor set 310 may be located “off chip.” In some computing environments, processor set 310 may be designed for working with qubits and performing quantum computing.

Computer readable program instructions can be loaded onto computing system 301 to cause a series of operational steps to be performed by processor set 310 of computing system 301 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in various types of computer readable storage media, such as cache 321 and the other storage media discussed herein. The program instructions, and associated data, can be accessed by processor set 310 to control and direct performance of the inventive methods. In computing environments of FIGS. 3-2, at least some of the instructions for performing the inventive methods may be stored in persistent storage 313, volatile memory 312, and/or cache 321, as application(s) 350 comprising one or more running processes, services, programs and installed components thereof. For example, program instructions, processes, services and installed components thereof may include the components and/or sub-components of the system 100 as shown in FIG. 1.

Communication fabric 311 may refer to signal conduction paths that may allow the various components of computing system 301 to communicate with each other. For example, communications fabric 311 can provide for electronic communication among the processor set 310, volatile memory 312, persistent storage 313, peripheral device set 314 and/or network module 315. Communication fabric 311 can be made of switches and/or electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 may refer to any type of volatile memory now known or to be developed in the future, and may be characterized by random access, but this is not required unless affirmatively indicated. Examples include dynamic type random access memory (RAM) or static type RAM. In computing system 301, the volatile memory 312 is located in a single package and can be internal to computing system 301, but, alternatively or additionally, the volatile memory 312 may be distributed over multiple packages and/or located externally with respect to computing system 301. Application 350, along with any program(s), processes, services, and installed components thereof, described herein, may be stored in volatile memory 312 and/or persistent storage 313 for execution and/or access by one or more of the respective processor sets 310 of the computing system 301.

Persistent storage 313 can be any form of non-volatile storage for computers that may be currently known or developed in the future. The non-volatility of this storage means that the stored data may be maintained regardless of whether power is being supplied to computing system 301 and/or directly to persistent storage 313. Persistent storage 313 may be a read only memory (ROM), however, at least a portion of the persistent storage 313 may allow writing of data, deletion of data and/or re-writing of data. Some forms of persistent storage 313 may include magnetic disks, solid-state storage devices, hard drives, flash-based memory, erasable read-only memories (EPROM) and semi-conductor storage devices. Operating system 322 may take several forms, such as various known proprietary operating systems or open-source Portable Operating System Interface type operating systems that employ a kernel.

Peripheral device set 314 includes one or more peripheral devices connected to computing system 301. For example, via an input/output (I/O interface). Data communication connections between the peripheral devices and the other components of computing system 301 may be implemented using various methods. For example, through connections using Bluetooth, Near-Field Communication (NFC), wired connections or cables (such as universal serial bus (USB) type cables), insertion type connections (for example, secure digital (SD) card), connections made though local area communication networks and/or wide area networks such as the internet. In various embodiments, UI device set 323 may include components such as a display screen, speaker, microphone, wearable devices (such as goggles, headsets and smart watches), keyboard, mouse, printer, touchpad, game controllers, and haptic feedback devices. Storage 324 can include external storage, such as an external hard drive, or insertable storage, such as an SD card. Storage 324 may be persistent and/or volatile. In some embodiments, storage 324 may take the form of a quantum computing storage device for storing data in the form of qubits. In some embodiments, networks of computing systems 301 may utilize clustered computing and components acting as a single pool of seamless resources when accessed through a network by one or more computing systems 301. For example, a storage area network (SAN) that is shared by multiple, geographically distributed computer systems 301 or network-attached storage (NAS) applications. IoT sensor set 325 can be made up of sensors that can be used in Internet-of-Things applications. For example, a sensor may be a temperature sensor, motion sensor, infrared sensor or any other type of known sensor type.

Network module 315 may include a collection of computer software, hardware, and/or firmware that allows computing system 301 to communicate with other computer systems through a network 302, such as a LAN or WAN. Network module 315 may include hardware, such as modems or Wi-Fi signal transceivers, software for packetizing and/or de-packetizing data for communication network transmission, and/or web browser software for communicating data over the network. In some embodiments, network control functions and network forwarding functions of network module 315 are performed on the same physical hardware device. In other embodiments (for example, embodiments that utilize software-defined networking (SDN)), the control functions and the forwarding functions of network module 315 can be performed on physically separate devices, such that the control functions manage several different network hardware devices. Computer readable program instructions for performing the inventive methods can typically be downloaded to computing system 301 from an external computer or external storage device through a network adapter card or network interface included in network module 315.

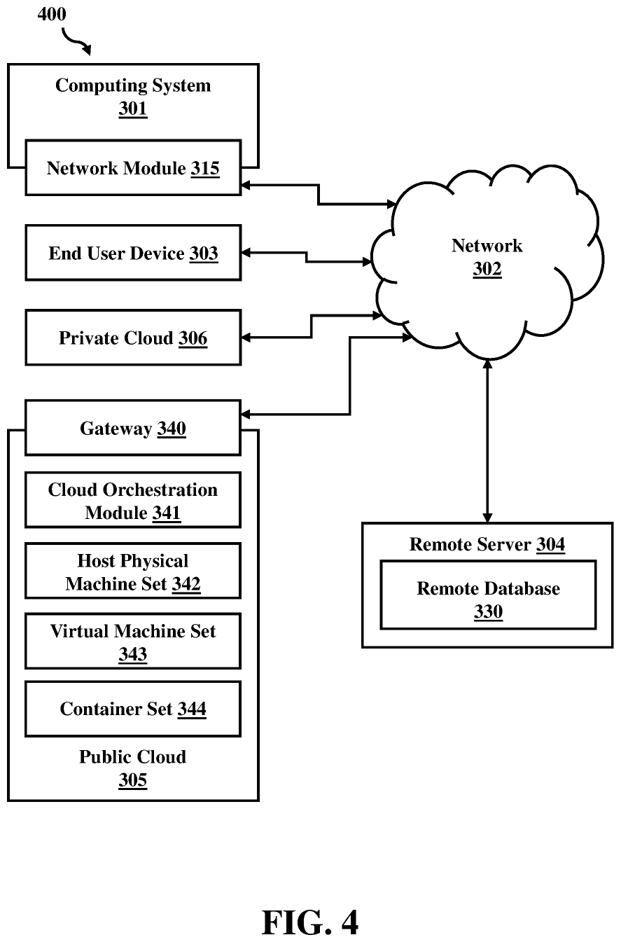

Continuing, FIG. 4 depicts a computing environment 400 which may be an extension of the computing environment 300 of FIG. 3, operating as part of a network. In addition to computing system 301, computing environment 400 can include a network 302 such as a wide area network (WAN) (or another type of computer network) connecting computing system 301 to an end user device (EUD) 303, remote server 304, public cloud 305, and/or private cloud 306. In this embodiment, computing system 301 includes processor set 310 (including processing circuitry 340 and cache 321), communication fabric 311, volatile memory 312, persistent storage 313 (including operating system 322 and program(s) 350, as identified above), peripheral device set 314 (including user interface (UI), device set 323, storage 324, Internet of Things (IoT) sensor set 325), and network module 315. Remote server 304 includes remote database 330. Public cloud 305 includes gateway 340, cloud orchestration module 341, host physical machine set 342, virtual machine set 343, and/or container set 344.

Network 302 may be comprised of wired or wireless connections. For example, connections may be comprised of computer hardware such as copper transmission cables, optical transmission fibers, wireless transmission, routers, firewalls, switches, gateway computers and/or edge servers. Network 302 may be described as any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. Other types of networks that can be used to interconnect the various computer systems 301, end user devices 303, remote servers 304, private cloud 306 and/or public cloud 305 may include Wireless Local Area Networks (WLANs), home area network (HAN), backbone networks (BBN), peer to peer networks (P2P), campus networks, enterprise networks, the Internet, single tenant or multi-tenant cloud computing networks, the Public Switched Telephone Network (PSTN), and any other network or network topology known by a person skilled in the art to interconnect computing systems 301.

End user device 303 can include any computer device that can be used and/or controlled by an end user (for example, a customer of an enterprise that operates computing system 301) and may take any of the forms discussed above in connection with computing system 301. EUD 303 may receive helpful and useful data from the operations of computing system 301. For example, in a hypothetical case where computing system 301 is designed to provide a recommendation to an end user, this recommendation may be communicated from network module 315 of computing system 301 through WAN 302 to EUD 303. In this example, EUD 303 can display, or otherwise present, the recommendation to an end user. In some embodiments, EUD 303 may be a client device, such as thin client, thick client, mobile computing device such as a smart phone, mainframe computer, desktop computer and so on.

Remote server 304 may be any computing systems that serves at least some data and/or functionality to computing system 301. Remote server 304 may be controlled and used by the same entity that operates computing system 301. Remote server 304 represents the machine(s) that collect and store helpful and useful data for use by other computers, such as computing system 301. For example, in a hypothetical case where computing system 301 is designed and programmed to provide a recommendation based on historical data, the historical data may be provided to computing system 301 from remote database 330 of remote server 304.

Public cloud 305 may be any computing systems available for use by multiple entities that provide on-demand availability of computer system resources and/or other computer capabilities including data storage (cloud storage) and computing power, without direct active management by the user. The direct and active management of the computing resources of public cloud 305 can be performed by the computer hardware and/or software of cloud orchestration module 341.

The computing resources provided by public cloud 305 can be implemented by virtual computing environments that run on various computers making up the computers of host physical machine set 342, and/or the universe of physical computers in and/or available to public cloud 305. The virtual computing environments (VCEs) may take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through network 302.

VCEs can be stored as “images.” A new active instance of the VCE can be instantiated from the image. Two types of VCEs may include virtual machines and containers. A container is a VCE that uses operating-system-level virtualization, in which the kernel allows the existence of multiple isolated user-space instances, called containers. These isolated user-space instances may behave as physical computers from the point of view of programs 350 running in them. An application 350 running on an operating system 322 can utilize all resources of that computer, such as connected devices, files and folders, network shares, CPU power, and quantifiable hardware capabilities. Applications 350 running inside a container of container set 344 may only use the contents of the container and devices assigned to the container, a feature which may be referred to as containerization.

Private cloud 306 may be similar to public cloud 305, except that the computing resources may only be available for use by a single enterprise. While private cloud 306 is depicted as being in communication with network 302 (such as the Internet), in other embodiments a private cloud 306 may be disconnected from the internet entirely and only accessible through a local/private network. A hybrid cloud may refer to a composition of multiple clouds of different types (for example, private, community or public cloud types), and the plurality of clouds may be implemented or operated by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 may be both part of a larger hybrid cloud environment.

What is claimed is:

1. A computer implemented method, the method comprising:
receiving, by a processor, environment data associated with a robotic device in an environment;
analyzing the environment data to identify one or more activities the robotic device performs in the environment;
generating one or more simulations associated with the one or more activities and the robotic device;
determining one or more limitations of the robotic device associated with the one or more activities; and
identifying, responsive to determining one or more limitations, one or more apparatuses, wherein the one or more apparatuses are associated with the one or more limitations.

2. The computer implemented method of claim 1, further comprising:
identifying a primary apparatus from the one or more apparatuses, wherein the primary apparatus is based, at least in part, on the one or more limitations;
determining an optimal method of attaching the primary apparatus to the robotic device; and
attaching the primary apparatus to the robotic device with the optimal method.

3. The computer implemented method of claim 2, further including:
analyzing the environment data and the one or more robotic devices with the primary apparatus;
determining one or more secondary limitations associated with the one or more robotic devices with the primary apparatus and the one or more activities; and
identifying a secondary apparatus from the one or more apparatuses, wherein the secondary apparatus is based, at least in part, on the one or more secondary limitations.

4. The computer implemented method of claim 3, further including:
simulating the secondary apparatus and the one or more robotic device with the primary apparatus;
determining an optimal method of attaching the secondary apparatus to the robotic device; and
attaching the secondary apparatus to the robotic device with the optimal method of attaching the secondary apparatus.

5. The computer implemented method of claim 1, further comprising:
identifying a primary apparatus and a secondary apparatus from the one or more apparatuses, wherein the primary apparatus and the secondary apparatus are based, at least in part, on the one or more limitations;
determining an optimal method of attaching the primary apparatus and the secondary apparatus to the robotic device; and
attaching the primary apparatus and the secondary apparatus to the robotic device with the optimal method.

6. The computer implemented method of claim 1, further comprising:
analyzing the environment data associated with the environment;
identifying an additional robotic device performing the one or more activities;
simulating the additional robotic device to determine the one or more limitations of the additional robotic device; and
identifying, responsive to determining the one or more limitations of the additional robotic device, one or more other apparatuses, wherein the one or more other apparatuses are associated with the one or more limitations of the additional robotic device.

7. The computer implemented method of claim 1, wherein generating the one or more simulations associated with the one or more activities and the one or more robotic devices is based at least in part on one or more digital twins of the robotic device and the environment.

8. A system, the system comprising:
a memory; and
a processor in communication with the memory, the processor being configured to perform operations comprising:
receiving environment data associated with a robotic device in an environment;
analyzing the environment data to identify one or more activities the robotic device performs in the environment;
generating one or more simulations associated with the one or more activities and the robotic device;
determining one or more limitations of the robotic device associated with the one or more activities; and
identifying, responsive to determining one or more limitations, one or more apparatuses, wherein the one or more apparatuses are associated with the one or more limitations.

9. The system of claim 8, further comprising:
identifying a primary apparatus from the one or more apparatuses, wherein the primary apparatus is based, at least in part, on the one or more limitations;
determining an optimal method of attaching the primary apparatus to the robotic device; and
attaching the primary apparatus to the robotic device with the optimal method.

10. The system of claim 9, further including:
analyzing the environment data and the one or more robotic devices with the primary apparatus;
determining one or more secondary limitations associated with the one or more robotic devices with the primary apparatus and the one or more activities; and
identifying a secondary apparatus from the one or more apparatuses, wherein the secondary apparatus is based, at least in part, on the one or more secondary limitations.

11. The system of claim 10, further including:
simulating the secondary apparatus and the one or more robotic device with the primary apparatus;
determining an optimal method of attaching the secondary apparatus to the robotic device; and
attaching the secondary apparatus to the robotic device with the optimal method of attaching the secondary apparatus.

12. The system of claim 8, further comprising:
identifying a primary apparatus and a secondary apparatus from the one or more apparatuses, wherein the primary apparatus and the secondary apparatus are based, at least in part, on the one or more limitations;
determining an optimal method of attaching the primary apparatus and the secondary apparatus to the robotic device; and
attaching the primary apparatus and the secondary apparatus to the robotic device with the optimal method.

13. The system of claim 8, further comprising:
analyzing the environment data associated with the environment;
identifying an additional robotic device performing the one or more activities;
simulating the additional robotic device to determine the one or more limitations of the additional robotic device; and
identifying, responsive to determining the one or more limitations of the additional robotic device, one or more other apparatuses, wherein the one or more other apparatuses are associated with the one or more limitations of the additional robotic device.

14. The system of claim 8, wherein generating the one or more simulations associated with the one or more activities and the one or more robotic devices is based at least in part on one or more digital twins of the robotic device and the environment.

15. A computer program product comprising a computer readable storage medium having program instructions embodied therewith, the program instructions executable by a processor to cause the processor to perform operations, the operations comprising:
receiving environment data associated with a robotic device in an environment;
analyzing the environment data to identify one or more activities the robotic device performs in the environment;
generating one or more simulations associated with the one or more activities and the robotic device;
determining one or more limitations of the robotic device associated with the one or more activities; and
identifying, responsive to determining one or more limitations, one or more apparatuses, wherein the one or more apparatuses are associated with the one or more limitations.

16. The computer program product of claim 15, further comprising:
identifying a primary apparatus from the one or more apparatuses, wherein the primary apparatus is based, at least in part, on the one or more limitations;
determining an optimal method of attaching the primary apparatus to the robotic device; and
attaching the primary apparatus to the robotic device with the optimal method.

17. The computer program product of claim 16, further including:
analyzing the environment data and the one or more robotic devices with the primary apparatus;
determining one or more secondary limitations associated with the one or more robotic devices with the primary apparatus and the one or more activities; and
identifying a secondary apparatus from the one or more apparatuses, wherein the secondary apparatus is based, at least in part, on the one or more secondary limitations.

18. The computer program product of claim 17, further including:
simulating the secondary apparatus and the one or more robotic device with the primary apparatus;
determining an optimal method of attaching the secondary apparatus to the robotic device; and
attaching the secondary apparatus to the robotic device with the optimal method of attaching the secondary apparatus.

19. The computer program product of claim 15, further comprising:
identifying a primary apparatus and a secondary apparatus from the one or more apparatuses, wherein the primary apparatus and the secondary apparatus are based, at least in part, on the one or more limitations;
determining an optimal method of attaching the primary apparatus and the secondary apparatus to the robotic device; and
attaching the primary apparatus and the secondary apparatus to the robotic device with the optimal method.

20. The computer program product of claim 15, further comprising:
analyzing the environment data associated with the environment;
identifying an additional robotic device performing the one or more activities;
simulating the additional robotic device to determine the one or more limitations of the additional robotic device; and
identifying, responsive to determining the one or more limitations of the additional robotic device, one or more other apparatuses, wherein the one or more other apparatuses are associated with the one or more limitations of the additional robotic device.
